(19) United States
(12) Patent Application Publication
(10) Pub. No.: US 2009/0287980 A1
(43) Pub. Date: Nov. 19, 2009

(54) Computational Architecture for Soft Decoding

(75) Inventors: Sergey Gribok, San Jose, CA (US); Alexander Andreev, San Jose, CA (US)

Correspondence Address: RYAN, MASON & LEWIS, LLP, 90 FOREST AVENUE, LOCUST VALLEY, NY, 11560, US

(73) Assignee: LSI CORPORATION, Milpitas, CA (US)

(21) Appl. No.: 12/121,824

(22) Filed: May 16, 2008

(51) Int. Cl. G06F 11/08; G06F 15/76; G06F 9/02

(52) U.S. Cl. 714/752; 712/29; 712/E09.002; 714/E11.03

(57) ABSTRACT

A device for soft decoding contains a set of operational elements, each being capable of performing one of several different functions. The operational elements may be dynamically configured with input and output connections to registers, memory locations, and other operational elements to perform various steps in a soft decoding scheme. In many cases, the operational elements may be configured to operate in a pipeline mode where many sequences of operations may be performed in parallel. Some embodiments may be reconfigured at each clock cycle to perform different steps during a decoding operation. The device may be used to perform several different soft decoding schemes with the flexibility of a programmable processor but the throughput of a hardware implementation.

### BACKGROUND

Forward error correcting codes are used in many digital communications and storage systems. Such codes use redundant data in messages, also known as error correction code. This may enable a receiver to detect and correct errors without requesting the sender to transmit additional data. Such codes are used in many communications and data storage systems.

“Soft decoding” may refer to using probabilistic information as input to a decoding algorithm, as opposed to “hard decoding” where the input may be a sequence of symbols such as bits. There are several classes of soft decoding. The classes include turbo codes, convolutional codes, and low density parity check (LDPC) codes. In each class of codes, there may be several different types of implementations of those codes.

A typical soft decoding scheme may involve a large amount of computation if performed by a typical general purpose processor. Such architectures may have an advantage in being flexible and adaptable to changing between different forward error correcting codes, but may not be able to support high levels of throughput. Other architectures may use a dedicated hardware processor that is specially configured for high speed decoding, but such architectures may not be adaptable to different decoding schemes.

### SUMMARY

A device for soft decoding contains a set of operational elements, each being capable of performing one of several different functions. The operational elements may be dynamically configured with input and output connections to registers, memory locations, and other operational elements to perform various steps in a soft decoding scheme. In many cases, the operational elements may be configured to operate in a pipeline mode where many sequences of operations may be performed in parallel. Some embodiments may be reconfigured at each clock cycle to perform different steps during a decoding operation. The device may be used to perform several different soft decoding schemes with the flexibility of a programmable processor but the throughput of a hardware implementation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system for forward error correcting processing.

FIG. 2 is a flowchart illustration of an embodiment showing a method for operating a device as in FIG. 1.

FIG. 3 is a diagram illustration of an embodiment showing a portion of a turbo code calculation.

FIG. 4 is a diagram illustration of an embodiment showing a first step in a three step sequence for executing a calculation.

FIG. 5 is a diagram illustration of an embodiment showing a second step in a three step sequence for executing a calculation.

FIG. 6 is a diagram illustration of an embodiment showing a third step in a three step sequence for executing a calculation.

FIG. 7 is a diagram illustration of an embodiment showing a configuration for processing beta elements in a turbo code.

### DETAILED DESCRIPTION

A soft decoder may have several operational elements, each of which may perform a function during a clock cycle. The operational elements may be configured with input and output connections to various registers, memory locations, and other operational elements. In many configurations, several operational elements may be configured in a pipeline configuration to process many pieces of data in parallel over a series of operations.

The soft decoder may offer a flexible platform for high speed decoding. The soft decoder may be configured to decode using many different codes, including turbo codes, convolutional codes, and low density parity check (LDPC) codes. In many cases, a soft decoder may also be adaptable to different variations within a general code type.

The soft decoder may be implemented in a single integrated circuit, and may use high speed, hardware implemented functions to perform various operations. By using multiple operational elements and connecting those elements in series, multiple operations may be performed in parallel thus increasing throughput dramatically.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

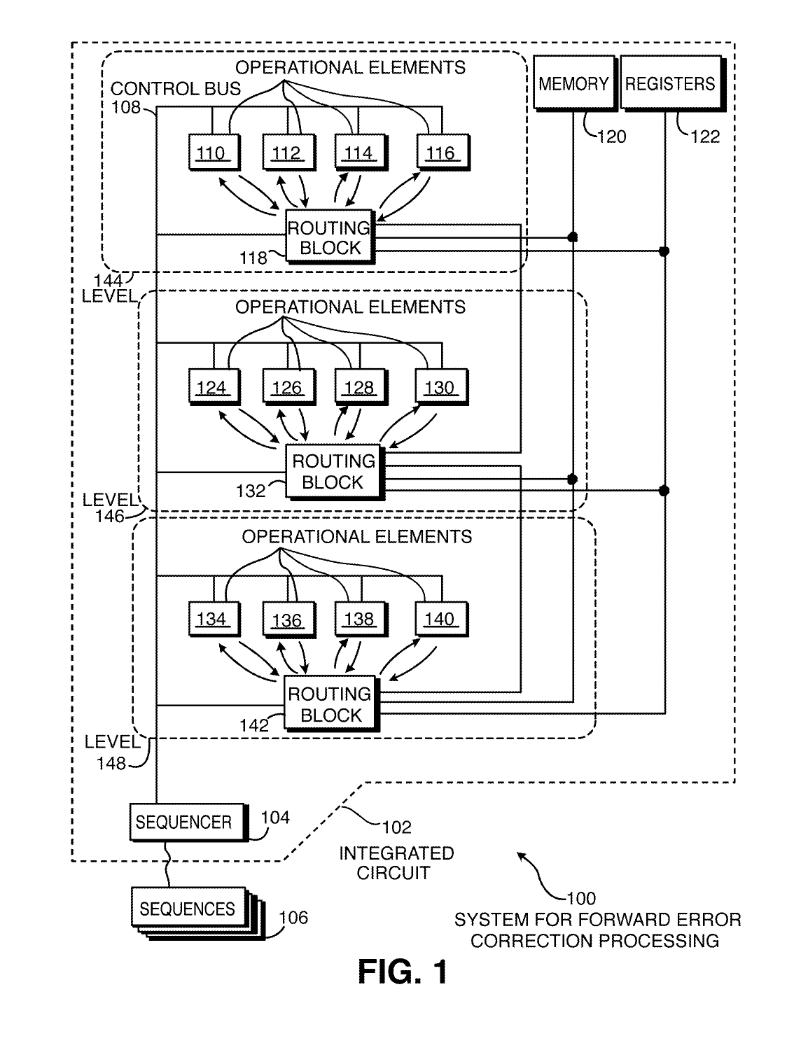

FIG. 1 is a diagram of an embodiment 100 showing a system for performing forward error correction processes on data. The embodiment 100 is an example of an architecture that may be used in an integrated circuit to decode communications that are transmitted with forward error correction. The architecture may use several independent operational elements to perform a function on incoming data. The operational elements may be configured or mapped to various memory locations, registers, and other operational elements, and may process data in a pipeline fashion where multiple operations are performed in parallel.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 100 is a reconfigurable processing system that may be used for encoding and decoding various forward error correcting communications. Embodiment 100 uses a set of configurable operational elements that may be mapped together in various manners. The operational elements may each perform an operation during a clock cycle, enabling many parallel operations to execute simultaneously. In some cases, the operational elements may be arranged in series to form a pipeline, where one operational element feeds another in sequence. Such a configuration may be well suited to processing data that are presented in series, such as a string of words transmitted in a communication packet.

Forward error correcting communications are used in many different applications, including cellular telephony, wireless broadband, Bluetooth communications, satellite communications, and other communications where noise may interfere with transmission. Forward error correction generally sends extra data that may be used to identify if an error has occurred, and some techniques enable the receiving device to determine the correct data.

Soft decoding is a general technique that uses probabilities to determine the most probable data that was transmitted. Examples of soft decoding include turbo codes, convolutional codes, and low density parity check (LDPC) codes. Each code may be implemented in different manners and different variations may be used. Some implementations may be an approximation of a theoretical code using various computational techniques.

Soft decoding techniques can be computationally intensive. By using several operational elements, each able to perform a function or computation, many operations may be performed in parallel. Such arrangements may process large amounts of data with several simple operational elements.

Embodiment 100 is an example of a system that may be implemented on a single integrated circuit 102. Such an embodiment may be used to create an adaptable forward error correcting decoder for use in various communications systems. In some embodiments, the integrated circuit 102 may be configured and used for one specific type of forward error correcting code, and the same design may be used in a different device that uses a different forward error correcting code. Some embodiments may change from one type of forward error correcting code to another in the same device.

The embodiment 100 may use a sequencer 104 that may implement various sequences 106. The sequences 106 may contain various steps used to implement a forward error correction code. Within each step, the sequencer 104 may send signals across a control bus 108 to configure the various operational elements and routing blocks to execute an operation on the next clock cycle.

In many embodiments, the various components may be configured to operate on a clock cycle or beat. On each clock cycle, an operational element may perform one operation and pass the data to the recipient of the data.

The operational elements 110, 112, 114, and 116 may each perform a function during an operation. The routing block 118 may arrange each operational element to connect to an input and output. The routing block 118 may enable an operational element to connect to a memory location 120, register location 122, or another operational element.

Each operational element may be able to perform one of several different functions. For example, a function may be to add two groups of data, determine a difference, determine a maximum or minimum, or perform other operations. In some cases, complex functions may be performed by an operational element, and some such functions may use a lookup table for implementation.

Many embodiments may use dedicated hardware circuits to perform one or more of the functions for an operational element. When hardware circuits are used to perform a function, the function may be performed very quickly especially when compared to programmable general purpose processors that may use several steps to perform a similar function.

The operational elements may be capable of performing several different functions. In many embodiments, two or more functions may be implemented in hardware and a switch or multiplexer may be used to select between the hardware functions. The sequencer 104 may send a signal along the control bus 108 to configure an operational element to the desired function.

The sequencer 104 may also send a signal or set of signals to the routing block 118 to establish the input and output paths for each operational element. For example, operational element 110 may be configured to receive input from a memory location 120 and a register 122. An output path for the operational element 110 may be an input path for operational element 112.

The sequencer 104 may be capable of organizing the operational elements into a pipeline or series of operations. Each operational element may perform a function on data, then pass the results to one or more other operational elements, that may in turn perform functions and pass the results to yet more operational elements. In such a situation, a pipeline of three, four, five, or more operations may be performed in series, with an equal number of data sets being operated upon at each clock cycle. In such a situation, a high data throughput may be achieved.

The group of operational elements 110, 112, 114, and 116 may be grouped together using routing block 118 and may be referred to as a level 144. A second level 146 may include a group of operational elements 124, 126, 128, and 130 connected using routing block 132, and a third level 148 may include operational elements 134, 136, 138, and 140 and routing block 142.

In many embodiments, separating operational elements may enable simpler routing blocks to be used. A routing block may be capable of routing any memory location or registry to an operational element and routing any operational element within a level to another operational element in that level or to a neighboring level.

Some operational elements may be capable of different functions than other operational elements. Some operational elements may have a large set of general purpose functions, while other operational elements may have a small set of specialized functions that perform specific complex functions that are used in particular forward error correction codes.

Different embodiments may have different numbers of operational elements and may configure the operational elements in different manners. In embodiments with many operational elements, a large number of operations may be performed in parallel and a higher throughput may be achieved. However, larger numbers of operational elements may also include more complexities in design and programming, as well as larger space used in an integrated circuit.

In many embodiments, a sequencer 104 may be capable of configuring the operational elements and routing blocks in between each clock cycle. In such cases, the sequences 106 may be used to perform complex calculations and operations with very high throughput using simple operational elements.

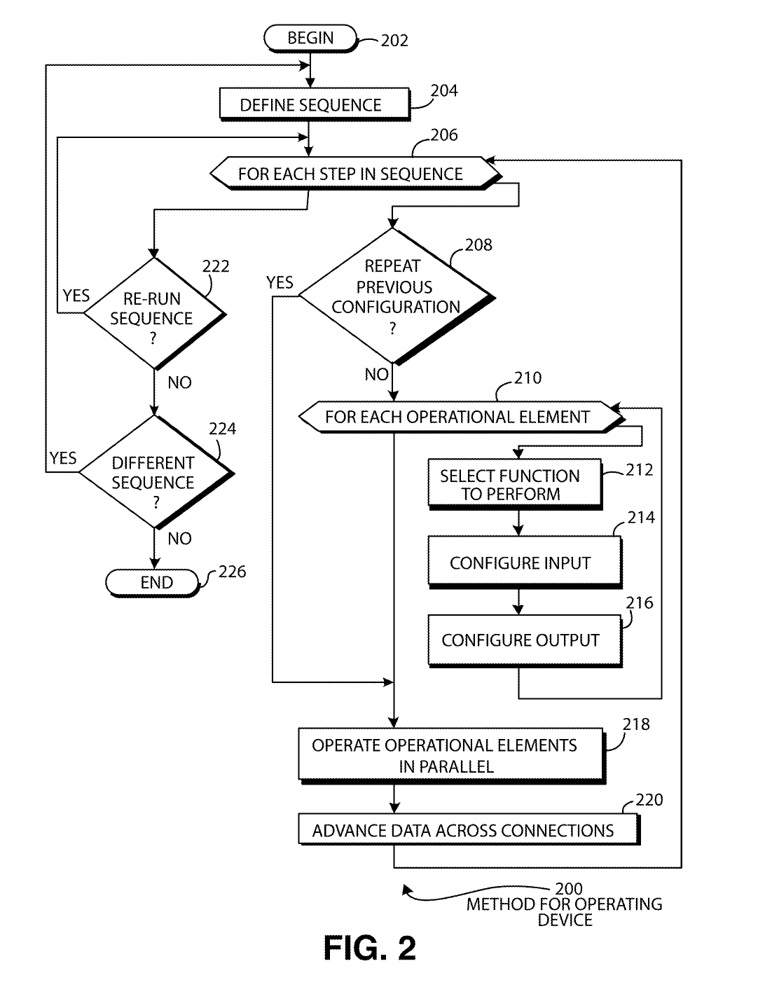

FIG. 2 is a flowchart illustration of an embodiment 200 showing a method for operating a device such as embodiment 100. Embodiment 200 illustrates a method for implementing a sequence of operations with a set of operational elements. The operational elements may be configured for a particular clock cycle step, then operated in parallel to each perform a function. In between steps, the connections between operational elements and the function of the operational elements may be changed.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 is an example of an operational sequence that may be followed to configure and operate a group of operational elements such as embodiment 200.

The process may begin in block 202. A sequence may be defined in block 204 and loaded. The sequence may be a predefined set of operations that are performed on the set of operational elements.

For each step in the sequence in block 206, if the previous configuration is not to be repeated in block 208, the configuration may be changed. In many embodiments, the reconfigurable operational elements and connections between the elements may be changed at each clock cycle.

If the configuration is to be changed in block 208, for each operational element in block 210, a function for the element to perform may be selected in block 212, the input connections configured in block 214, and the output connections configured in block 216.

In a typical hardware implementation such as in an integrated circuit, each operational element may have two or more functions that may be performed by the operational element. Each function may be defined by a hardware circuit that is switchable by a multiplexer

A multiplexer may also be used to define the input and output paths for the operational element. The input and output paths may include connections to memory locations, registers, and other operational elements. In some cases, the output of one operational element may be connected to the input of a second operational element. In such a cases, a series of operations may be performed on a set of data.

After the configuration is set for a clock cycle, the operational elements may be operated in parallel in block 218. Because many different operational elements may be configured, each operational element may be used to perform an operation during a clock cycle. Such a configuration may process many data items in parallel.

The data may be advanced across the output connections in block 220 in preparation for the next clock cycle.

A sequence may be executed by configuring the operational elements differently in each step of the sequence. At an initial step, one operational element may be used to perform a function on a data element. The first operational element may be connected to two other operational elements in a second step. During the second step, the first operational element may perform an operation on a second data element in a string of data elements, while the other operational elements perform a second operation on the first operational element.

If a sequence is to be re-run in block 222, the process may return to block 206. In many embodiments, a sequence may be defined for processing a predefined group of data. For example, a sequence may be defined for processing a message packet that is encoded using one of several forward error correcting codes. The message packet may be processed by a sequence that performs various operations on the packet to decode the data. In such an example, each sequence of block 204 may process one message packet. In other embodiments, a sequence may be defined to process many sequential message packets or may be defined for some other function.

If a sequence is not re-run in block 222, a different sequence may be selected in block 224 and the process may return to block 204 In many embodiments, sequences may be defined for different forward error correcting schemes, and a single hardware platform may be configured to decode data from different forward error correction schemes by merely changing the sequence.

If no other sequences are to be run in block 224, the process may end in block 226.

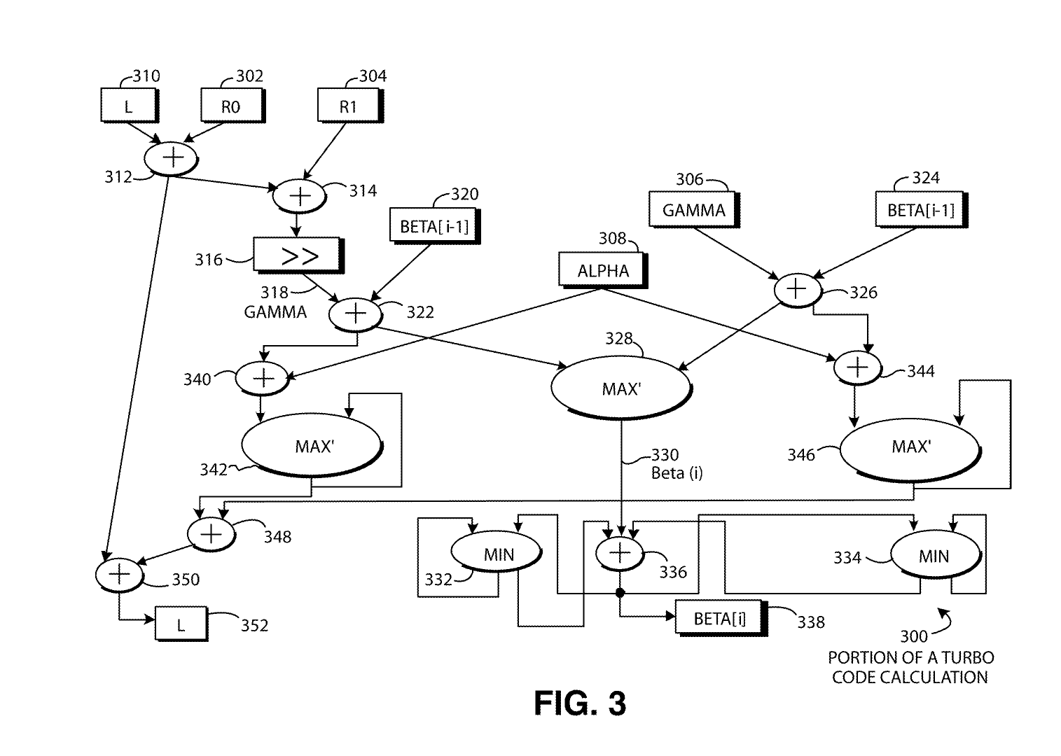

FIG. 3 is a diagram illustration of an embodiment 300 showing an overall configuration for performing a generalized turbo code. Embodiment 300 is a generalized example of a turbo code and corresponds to the simplified implementation of a turbo decoder as described in “An Intuitive Justification and a Simplified Implementation of the MAP Decoder for Convolutional Codes” by Andrew J. Viterbi as published in IEEE Journal on Selected Areas in Communications, Vol. 16, No. 2, February 1998, the entire contents of which are hereby expressly incorporated by reference.

Embodiment 300 is an example of a portion of the calculations that may be performed for decoding a turbo code. Embodiment 300 illustrates how portions of a complex code may be analyzed by using operational elements connected to registers, memory locations, and other operational elements. Embodiment 300 is a subset of the operations used to analyze a turbo code.

Soft information bits are received as R0 and R1 in blocks 302 and 304. R0 and R1 correspond to y0 and y1 in the following equation:

$${γ}_{l} ( {s}^{′} , s ) = \{ \begin{matrix}\frac{1}{2} ( - {L}_{l}^{i n} - {y}_{l}^{0} - {y}_{l}^{1} ) , & \{ {s}^{′} , 0 \} \to \{ s , 0 \} \\ \frac{1}{2} ( - {L}_{l}^{i n} - {y}_{l}^{0} + {y}_{l}^{1} ) , & \{ {s}^{′} , 0 \} \to \{ s , 1 \} \\ \frac{1}{2} ( + {L}_{l}^{i n} + {y}_{l}^{0} - {y}_{l}^{1} ) , & \{ {s}^{′} , 1 \} \to \{ s , 0 \} \\ \frac{1}{2} ( + {L}_{l}^{i n} + {y}_{l}^{0} + {y}_{l}^{1} ) , & \{ {s}^{′} , 1 \} \to \{ s , 1 \}\end{matrix}$$

Gamma is calculated using R0 in block 302 and an L parameter of block 310 that are added using the adding function of block 312. The output is sent to block 314 where the adding function joins R1 from block 304. The output of block 314 undergoes a >>(right shift) operation in block 316. The output of block 316 is Gamma 318. Gamma of block 306 may be similarly calculated but with a difference operator used in place of the addition operator of block 314.

Alpha is the forward state metric. Beta is the backward state metric. The Alpha values are calculated using the following equations:

$${α}_{0} ( s ) = \{ \begin{matrix}0 , & s = 0 \\ - ∞ , & s \neq 0\end{matrix} \\ {α}_{l + 1} ( s ) = max * [ {γ}_{l} ( {s}_{i}^{′} , s ) + {α}_{l} ( {s}_{i}^{′} ) , {γ}_{l} ( {s}_{j}^{′} , s ) + {α}_{l} ( {s}_{j}^{′} ) ]$$

where Alpha0 is calculated using the first equation. Alpha1 is calculated using the second equation using Gammas and Alpha0, then Alpha2 is calculated using the second equation using Gammas and Alpha1 and so on. The max* operator is defined as:

max*(x,y)=ln(e^{x}+e^{y})=max(x,y)+ln(1+e^{-|x-y|})

The backward state metrics Beta are calculated using the following equations:

$${β}_{K} ( s ) = \{ \begin{matrix}0 , & s = 0 \\ - ∞ , & s \neq 0\end{matrix} \\ {β}_{l} ( {s}^{′} ) = max * [ {γ}_{l} ( {s}^{′} , {s}_{i} ) + {β}_{l + 1} ( {s}_{i} ) , {γ}_{l} ( {s}^{′} , {s}_{j} ) + {β}_{l + 1} ( {s}_{j} ) ]$$

where BetaK is calculated using the first equation and K is the codeword size. Beta(K−1) is calculated using the second equation based on Gammas and BetaK, and Beta(K−2) is calculated using the second equation based on Gammas and Beta(K−1) and so on.

In embodiment 300, the elements of Beta are analyzed bit by bit, with i being the designator for the current bit being analyzed. Beta(i−1) in blocks 320 and 324 may be memory locations referring to the current bit being analyzed. The values of Beta(i−1) of block 320 is combined in block 322 and used as input to the max* operator of block 328. Similarly, Beta(i−1) of block 324 is combined with Gamma of block 306 using the addition operator of block 326 and used as input to block 328, the output of which is Beta(i) 330.

The value of Beta is normalized by subtracting the minimum value of Beta from the previous step from all Betas on the current step. The minimum operators of blocks 332 and 334 determine the minimum value of Beta from the current step and perform an effective subtraction operation in block 336 to give the final result of Beta(i) in block 338.

The calculation of L is performed according to the following equation:

$$L ( \text{?} ) = max * \text{?} [ {β}_{l + 1} ( s ) + {γ}_{l} ( {s}^{′} , s ) + {α}_{l} ( {s}^{′} ) ] - max * \text{?} \text{?}$$

$$\text{?} \text{indicates text missing or illegible when filed}$$

where the term Σₗ⁺ is a set of all state pairs (s′,s) corresponding to bit 1 of the source message at time l and Σₗ⁻ is a set of all state pairs (s′,s) corresponding to bit 0 of the source message at time l.

The value of Alpha in block 308 is combined with the combined Beta value of block 320 and Gamma 318 in block 340 and the max* operation is performed in block 342. Similarly, the value of Alpha in block 308 is combined with the combined Beta value of block 324 and Gamma of block 306 in block 344 and the max* operation is performed in block 346. The output of the two max* operators in blocks 342 and 346 are combined in block 348 with the sum of L of block 310 and R0 of block 302 in block 350 to yield the updated L value in block 352.

Embodiment 300 is an example of how a soft decoder may be configured from a group of operational elements and routing blocks that may connect the operational elements to memory locations, registers, and other operational elements. In embodiment 300, the operational elements include 312, 314, 316, 322, 326, 328, 332, 334, 336, 342, 344, 348, and 350. Registers may be used to store variables such as Gamma in block 306 and Gamma 318. Some values may be pulled from memory locations, such as Alpha of block 308, Beta(i−1) of blocks 320 and 322.

The output of some operational elements may be connected to other operational elements in a pipeline effect. For example, the value of Beta(i−1) in block 320 may go to the operational element in block 322, then forwarded to the operational element in block 340, then forwarded to the operational element in block 342, and so on. Each operational element may perform an operation on one value during a clock cycle, then pass the value to the next operational element and perform and operation on a second value during the next clock cycle. In such a fashion, a large number of sequential operations may be performed in parallel.

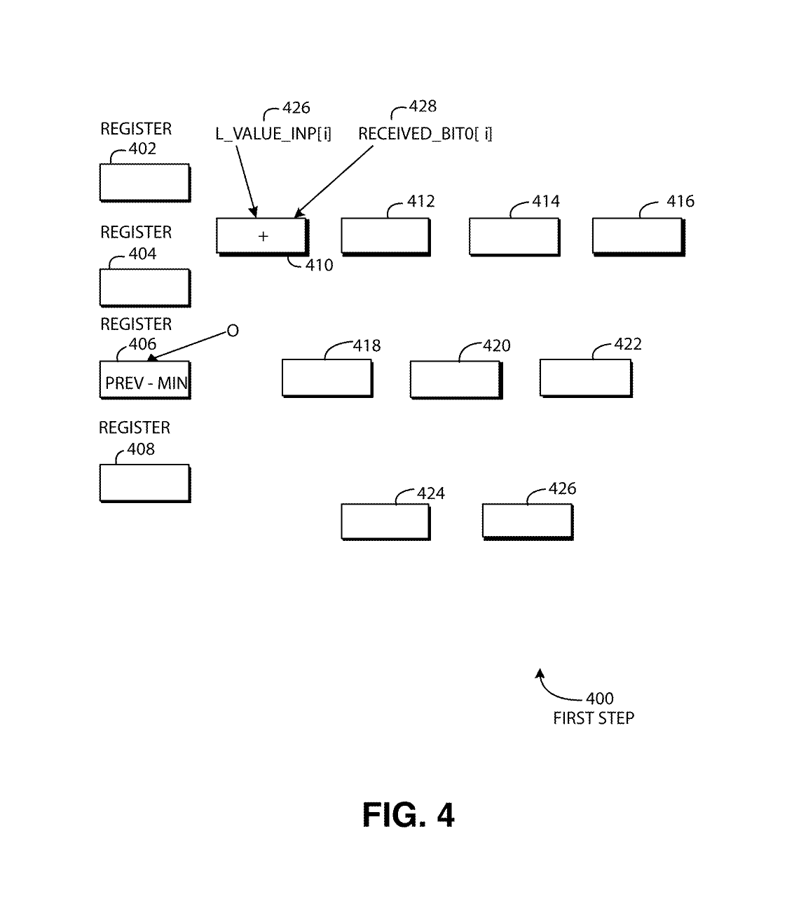

FIG. 4 is a diagram example of an embodiment 400 showing an example of a configuration for a set of operational elements and registers for a first step of calculating Gamma values. Three steps for performing the calculations are shown in FIGS. 4, 5, and 6 as embodiments 400, 500, and 600, respectively.

Embodiment 400 is an example of a configuration for a set of operational elements that may be reconfigured for performing different functions as well as connecting to different registries, memory locations, and other operational elements. Embodiment 400 represents the configuration of the operational elements and connections between the operational elements for a single clock cycle. In between each clock cycle, the operational elements and connections may be changed to perform a sequence of operations.

In embodiment 400, registers 402, 404, 406, and 408 are temporary storage areas for data. Operational elements 410, 412, 414, 416, 418, 420, 422, 424, and 426 may be configured to perform different operations on incoming data and may be configured to receive data from various sources and output data to various sources.

The operational elements are illustrated with incoming data presented from the top, and outgoing data from the bottom of the boxes. The function performed by the operational element is shown inside the element.

Embodiment 400 is the first step in a three step sequence for calculating two values of Gamma per the discussion of embodiment 300 above. In embodiment 400, L_VALUE_INP[i] as data element 426 and RECEIVED_BIT0[i] as data element 428 correspond with L in block 310 and RO in block 302. Operational element 410 is configured with an addition operator.

During the clock cycle represented by embodiment 400, the data elements 426 and 428 are connected to the operational element 410 and an addition operation is performed. Also performed, a zero value is loaded into register 406 and labeled as a previous minimum value. The previous minimum value may be used in later computations.

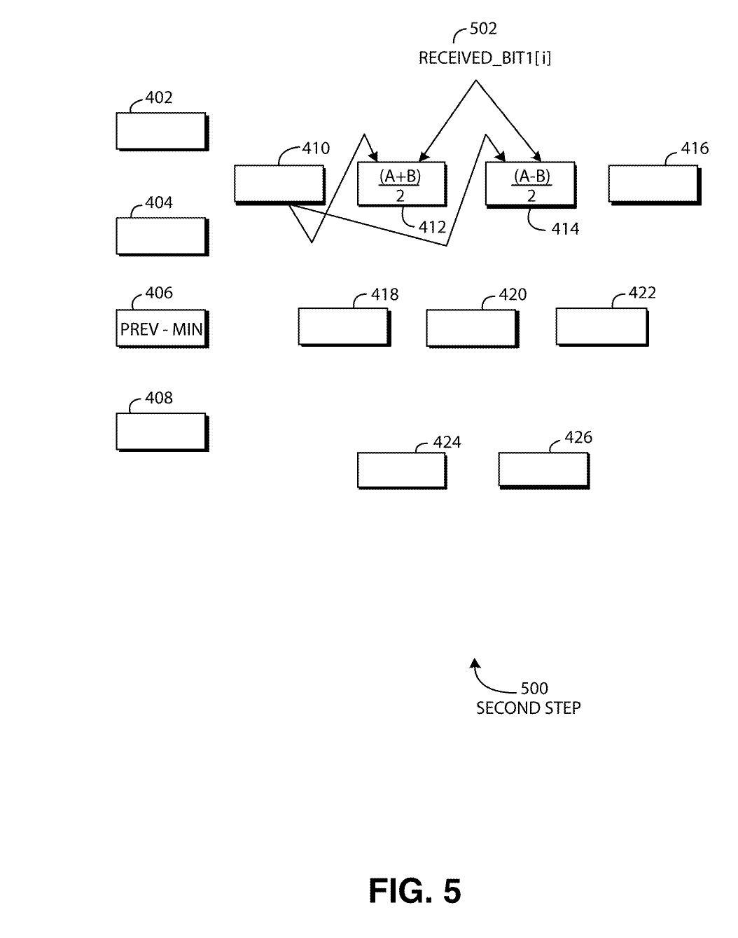

FIG. 5 is a diagram example of an embodiment 500 showing an example of a second step that follows embodiment 400.

In embodiment 500, the output of operational element 410 is transferred to operational elements 412 and 414, and a RECEIVED_BIT[i] data element 502 is also set as input to operational elements 412 and 414. Operational element 412 is configured to add the two inputs and divide by 2. Operational element 414 is configured to take the difference between the inputs and divide by 2.

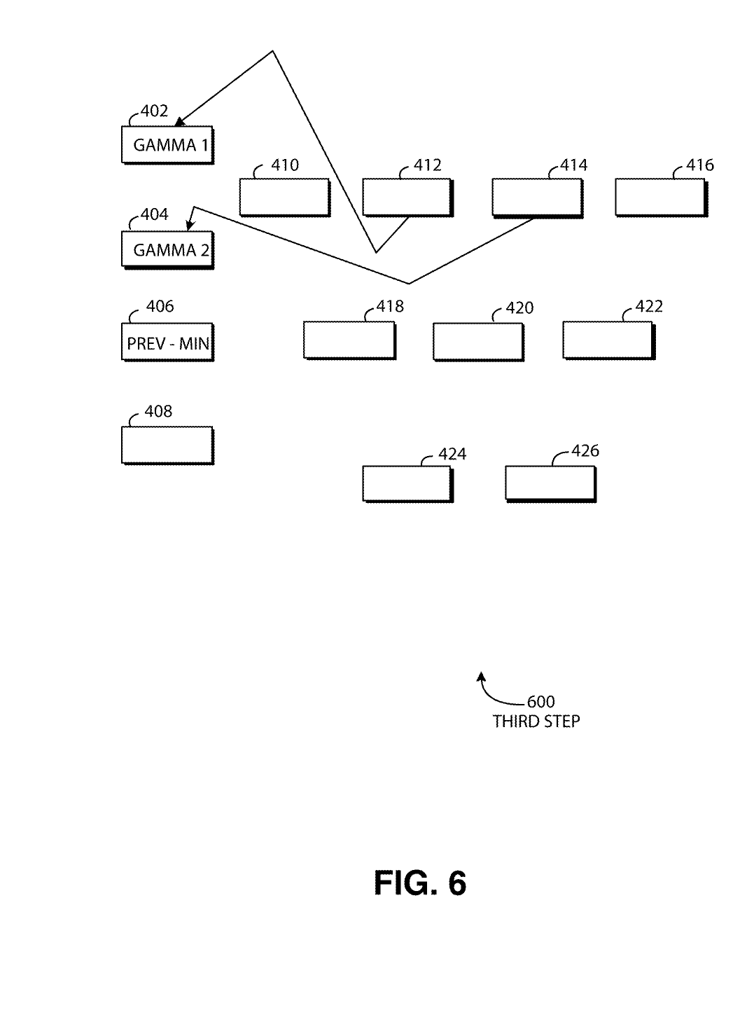

FIG. 6 is a diagram example of an embodiment 600 showing an example of a third step that follows embodiments 400 and 500.

In embodiment 600, the output of operational element 412 is connected to the input of register 402, which corresponds to the first Gamma value 318. The output of operational element 414 is connected to the input of register 404, which corresponds to the second Gamma value 306.

Embodiments 400, 500, and 600 are examples of a three step sequence for calculating Gamma values using a set of configurable operational elements with configurable connections between the elements. With each clock cycle, the operational elements and connections may be reassigned to perform different functions or pass data to another location.

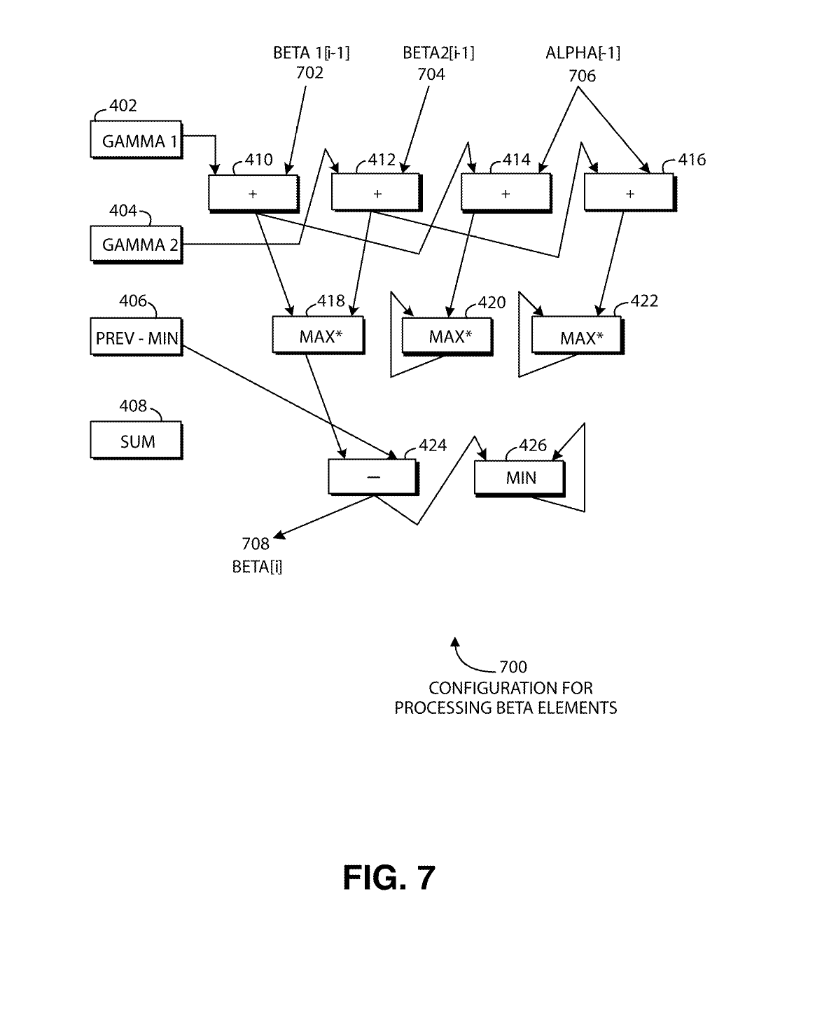

FIG. 7 is a diagram example of an embodiment 700 showing an example of a configuration for processing the individual Beta elements as described in embodiment 300. Embodiment 700 is an example of a pipeline of connections where a sequence of operations may be performed in parallel. With each clock cycle, an operational element may perform a function and pass the data to the next operational element, register, or memory location.

In embodiment 700, the Gamma value from register 402 is input to operational element 410 along with Beta1(i−1) as data element 702. Operational element 410 is configured as an addition operation. Similarly, Beta2(i−1) as data element 704 is input to operational element 412 along with Gamma2 from register 404. Operational element 412 is configured as an addition operation.

The outputs of operational elements 410 and 412 are connected to the input of operational element 418 which performs a max* operation, which may correspond to the max* operation of operational element 328 in embodiment 300.

The outputs of operational elements 410 and 412 are also connected to operational elements 414 and 416, respectively. Alpha(i−1) as data element 706 is also connected to the inputs of operational elements 414 and 416, both of which are configured as addition operations. The output of operational elements 414 and 416 are used as input to operational elements 420 and 422, respectively, which each perform a max* operation with recursive input. Operational elements 420 and 422 may correspond with operational elements 342 and 346, respectively.

The output of operational element 418 and register 406 are used as input to operational element 424, where a difference operation is performed. The output of operational element 424 is a Beta(i) data element 708. The output of operational element 424 is also used as input to operational element 426 which has a recursive input.

Embodiment 700 is an example of a configuration that may perform a series of sequential operations on a series of data elements. The operational elements may be configured in a pipeline configuration, where data from one element feeds another. With each clock cycle, a set of operations is performed in parallel and the output passed to the next operational element.

Embodiment 700 is an example of one step that may be repeated several times for each element or bit in a codeword.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a plurality of operational elements, each of said operational elements having a selectable function, and at least one of said operational elements being adapted to perform a function using a lookup table;
a selectable connection net configured to create an input connection and output connection to each of said operational elements to at least one memory location, register location, or another of said operational elements; and
a sequence executor configured to implement a connection configuration defining said input connection and said output connection to said operational elements and an operational configuration defining a function for said operational elements for a clock cycle and to perform at least one operation for said clock cycle.

2. The system of claim 1, said sequence executor being further configured to implement a sequence comprising a plurality of steps, each step having one of said connection configuration and said operational configuration.

3. The system of claim 2, said sequence being defined to execute a forward error correction decoding operation.

4. The system of claim 3, said forward error correction decoding operation being one of a group composed of:
turbo codes;
convolutional codes; and
low density parity check codes.

5. The system of claim 2, said forward error correction decoding operation being performed in a plurality of steps.

6. The system of claim 2, said forward error correction decoding operation being performed in a single step.

7. The system of claim 1, at least one of said operational elements being comprised of a plurality of hardware executable functions and a multiplexer adapted to select between said plurality of hardware executable functions.

8. The system of claim 7, said system being implemented on a single integrated circuit.

9. The system of claim 1, said selectable function being one of a group composed of:
a summation operation;
a difference operation;
a shift operation;
a maximum operation; and
a minimum operation.

10. The system of claim 1, said operational elements being configurable to execute a pipeline of operations in parallel for a plurality of said clock cycles.

11. The system of claim 1 comprising at least nine of said operational elements.

12. The system of claim 1, said operational elements being arranged in at least three levels.

13. A method comprising:
receiving a set of steps to be executed in successive clock cycles, said steps defining a forward error correction decoding process;
for each of said steps:
configuring each of a plurality of operational elements with a function to be performed, an input connection, and an output connection, said input connection and output connection being a connection to a register, a memory location, or another of said operational elements; and
operating said operational elements as configured.

14. The method of claim 13, said forward error correction decoding operation being one of a group composed of:
turbo codes;
convolutional codes; and
low density parity check codes.

15. The method of claim 13, said plurality of operational elements being configured in a pipeline configuration to perform a plurality of serial operations in parallel.

16. The method of claim 13, at least one of said operational elements being configured to perform at least one function using a lookup table.

17. The method of claim 13, a first subset of said plurality of operational elements having a first group of operations, and a second subset of said plurality of operational elements having a second group of operations.

18. A system comprising:
a plurality of operational elements, each of said operational elements having a selectable function, and at least one of said operational elements being adapted to perform a function using a lookup table, said plurality of operational elements being arranged into levels, each of said levels comprising a plurality of said operational elements;
a selectable connection net configured to create an input connection and output connection to each of said operational elements to at least one memory location, register location, or another of said operational elements; and
a sequence executor configured to implement a plurality of steps, each of said steps comprising a connection configuration defining said input connection and said output connection to said operational elements and an operational configuration defining a function for said operational elements for a clock cycle and to perform at least one operation for said clock cycle;
said steps defining a forward error correction decoding operation.

19. The system of claim 18, said forward error correction decoding operation being one of a group composed of:
turbo codes;
convolutional codes; and
low density parity check codes.

20. The system of claim 18 being comprised in a single integrated circuit.
